(19) United States
(12) Patent Application Publication
(10) Pub. No.: US 2020/0043114 A1
(43) Pub. Date: Feb. 6, 2020

(54) COMPUTER IMPLEMENTED METHOD AND A SYSTEM TO AUTHOR AND ACCESS MULTIMEDIA TRAINING CONTENT FOR CLOSED LOOP MARKETING CONTENT

(71) Applicants: Maruthi VISWANATHAN, Karnataka (IN); RxPrism Health Systems Private Limited, Karnataka (IN)

(72) Inventor: Maruthi VISWANATHAN, Karnataka (IN)

(21) Appl. No.: 16/653,144

(22) Filed: Oct. 15, 2019

(30) Foreign Application Priority Data
Oct. 16, 2018 (IN) 201841039258

(51) Int. Cl. G06Q 50/20; G06Q 30/02; G06Q 30/00

(52) U.S. Cl. CPC G06Q 50/2057; G06Q 30/016; G06Q 30/0201

(57) ABSTRACT

A computer implemented method to author and access multimedia training content for closed loop marketing content comprises authoring multimedia training content associated with a closed loop marketing content in a second set of user devices, storing the created multimedia training content associated with the closed loop marketing content as a network-based resource, opening the closed loop marketing content within a closed loop marketing platform in a first set of user devices, accessing a user interface by the first set of users for loading associated multimedia training content, loading associated multimedia training content as a foreground overlay on top of the closed loop marketing content and rendering and playing the multimedia training content.

### TECHNICAL FIELD

Embodiments of the present invention relate generally to multimedia training guide/content technologies and more particularly to a computer implemented method and a system to author and access multimedia training content for closed loop marketing content.

### BACKGROUND ART

Life sciences companies develop many digital materials for closed loop marketing called closed loop marketing content, also referred as digital materials or materials further on. These materials are used inwayith Customer Relationship Management (CRM) platform. These digital materials are used for promotional and non-promotional activity. Typically, these digital materials are developed for different Products, Brands and molecules. These digital materials undergo different medico-legal regulatory approvals before using in the market. These digital materials are used by field team like medical Reps and Medical Science Liaisons on their tablet or laptop devices within closed loop marketing platform/tools/apps during their detailing calls with Healthcare professionals (HCPs), hence these Digital materials are also called as E-Detail materials or interactive detail aid or interactive visual aid or closed loop marketing content. Field team is expected to present these digital materials with HCPs within the scope of content being approved by medical, legal & regulatory bodies for the discussion or promotion as required.

Typically, these digital materials are developed as a set of presentation slides and each slide may represent a key message or scientific information to be communicated with HCP during the call along with appropriate references. Once these digital materials are developed and ready to be used in the market. It is important that all field team like sales reps, medical reps and medical science liaisons should be trained on these materials thoroughly. So that they know “why” and “how” to present these digital materials to have very good productive calls with HCPs and also avoid certain incorrect information or FALSE CLAIMS being delivered or exchanged with HCPs which may lead to lawsuits by regulatory bodies.

For an example “False Claims Act” is an American federal law that imposes liability on persons and companies (typically federal contractors) who defraud governmental programs. Claims under the law have typically involved health care and other sectors but dominate the list of largest pharmaceutical settlements. So far multi-billion dollar fine/penalties paid by many top pharmaceutical companies for their False claim under False Claim Act and still it is a big challenge to tackle them.

All field team individuals are not equally educated or have the same knowledge or presentation skills to learn and deliver best ideal calls with HCPs using these digital materials during their calls. Misunderstanding or poor knowledge of these digital material content or scientific data mentioned in the digital materials lead to present half information or false claim with HCPs.

Many e-learning, blended learning solutions are developed and used in a print and digital form using Learning management systems to get trained on these topics discussed in digital materials. Also, many organizations conduct face to face workshops or remote training sessions to train field team on these digital materials. But these methods have shortcomings.

Moreover, the digital materials (closed loop marketing content) provides field team “what to present” but does not explain/provide “why” and “how” to present a particular key message/slide effectively.

The existing training systems provide solutions as a standalone disconnected from closed loop marketing platform and its closed loop marketing content (Digital materials). As they are disconnected, it fails to act as a true multimedia training guide content interlinked/associated with appropriate digital materials (closed loop marketing content) slide wise (key messages/claims) within closed loop marketing platform, like an instant help for each digital material (closed loop marketing content) slides accessed anytime just before the HCP meeting on the particular key message/scientific data which they would have forgotten the claims or need revision on appropriate information.

Also, existing systems do not deliver the on-demand just-in-time training content along with closed loop marketing content (digital materials) slide wise.

These systems follow standalone traditional login systems and serve e-learning module, do not have integrated authoring tool to create and interlink the training content with closed loop marketing materials (digital materials) of closed loop marketing platform.

These existing systems do not provide instant access to training content as a guide through a user interface like “help” along with closed loop marketing content (digital materials) slide wise, key message wise, claim wise within closed-loop marketing platform. Therefore, there is a need in the art for a system and a computer implemented method to author and access multimedia training content for closed loop marketing content which can overcome short comings of previous systems and solutions or at least provide a productive alternative to reduce the field team presentation errors and false claims.

### OBJECT OF THE INVENTION

An aspect of the present invention provides a system to author and access multimedia training content for closed loop marketing content.

Another aspect of the present invention provides a computer implemented method to author and access multimedia training content for closed loop marketing content.

### SUMMARY OF THE PRESENT INVENTION

The present invention provides field team an instant access to multimedia training content anytime like an help within the closed loop marketing platform along with particular closed loop marketing content (Digital materials) slide wise explaining “why” and “how” to present a particular key message or a slide, a claim effectively without any mistake or false claims.

The current invention has integrated authoring tool to create multimedia training content as foreground overlay with video, audio, avatar animation, slide pointer and highlighter animation for any closed loop marketing content and interlink with particular closed loop marketing content slide(s) of closed loop marketing platform.

The present invention is completely connected with closed loop marketing platform and its closed loop marketing content (Digital materials). Hence it act as an integrated, embedded, simulation based multimedia training guide content interlinked/associated with appropriate closed loop marketing content slide wise (key messages/claims) within closed loop marketing platform. It acts like an instant “help” for each closed loop marketing content slides accessed anytime by field team just before the HCP meeting on the particular key message/scientific data for quick revision on appropriate information and claims. These multimedia training content load and play as foreground overlay on top of any particular closed loop marketing content being opened in the closed loop marketing platform.

For an example the multimedia training content may contain role play video of any human individual explaining how to present particular closed loop marketing content slide/key message within the scope of approved claim along with screen pointer/highlighting animation.

Another example may play a video of any virtual avatar speaking through synthesised audio explaining the particular closed loop marketing content slide/key message within the scope of approved claim along with screen pointer/highlighting animation.

Hence, the current invention delivers the on-demand just-in-time training content for any closed loop marketing content (digital materials) slide wise without any additional login authentication user interface apart from closed loop marketing platform.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art.

According to a first aspect of the present invention, there is provided a computer implemented method to author and access multimedia training content for closed loop marketing content. The method comprises the steps of authoring multimedia training content associated with a closed loop marketing content in a second set of user devices operated by a second set of users, storing the created multimedia training content associated with the closed loop marketing content as a network-based resource, opening the closed loop marketing content within a closed loop marketing platform in a first set of user devices operated by a first set of users, accessing a user interface by the first set of users for loading associated multimedia training content, loading associated multimedia training content as a foreground overlay on top of the closed loop marketing content and rendering and playing the multimedia training content.

In accordance with an embodiment of the present invention, the step of authoring further comprises synthesising or adding or recording video along with audio or only audio narrating or describing the associated closed loop marketing content, capturing a second user interactions, with the closed loop marketing content in the background being navigated or changed or marked or opened and/or highlighted certain information in the closed loop marketing content as per video or audio narration timeline and get synchronized as interactivity data or media cue points and combining video with audio, audio, interactivity data and/or media cue points as the multimedia training content associated to the closed loop marketing content.

In accordance with an embodiment of the present invention, the step of rendering and playing further comprises playing the related video with audio or only audio narrating or describing associated closed loop marketing content opened in the background, rendering or simulating or animating the screen pointers, opening and/or highlighting the certain information in the associated closed loop marketing content in sync with video or audio narration timeline as per interactivity data or media cue points data.

In accordance with an embodiment of the present invention, the closed loop marketing content is a multimedia digital content used for closed loop marketing by first set of users on first set of user devices

In accordance with an embodiment of the present invention, the second set of user devices is a computing device with at least a processor, a memory and a display.

In accordance with an embodiment of the present invention, the second set of users are personnel involved in authoring the multimedia training content for any particular closed loop marketing content.

In accordance with an embodiment of the present invention, the closed loop marketing platform is one or multiple integrated computer software applications run on servers, tablets and mobile used for closed loop marketing with or without customer relationship management platform.

In accordance with an embodiment of the present invention, the first set of user devices are computing devices with at least a processor, a memory and a display.

In accordance with an embodiment of the present invention, the first set of users is a sales representative, or any personnel involved in customer engagement activity through closed loop marketing.

In accordance with an embodiment of the present invention, the synthesising includes speech synthesis, generating an audio from provided narration text data, also producing a video of an animated avatar with mouth and lip movements synchronized as per audio narration data.

According to a second aspect of the invention, there is provided a computer implemented method to access multimedia training content for closed loop marketing content. The method comprising the steps of, but not limited to, opening the closed loop marketing content within a closed loop marketing platform in a first set of user devices operated by a first set of users, accessing a user interface by the first set of users for loading associated multimedia training content, loading associated multimedia training content as a foreground overlay on top of the closed loop marketing content and rendering and playing the multimedia training content.

In accordance with an embodiment of the present invention, the step of rendering and playing further comprises playing the related video with audio or only audio narrating or describing associated closed loop marketing content opened in the background, rendering or simulating or animating the screen pointers, opening and/or highlighting the certain information in the associated closed loop marketing content in sync with video or audio narration timeline as per interactivity data or media cue points data.

In accordance with an embodiment of the present invention, the closed loop marketing content is a multimedia digital content used for closed loop marketing by first set of users on first set of user devices

In accordance with an embodiment of the present invention, the closed loop marketing platform is one or multiple integrated computer software applications run on servers, tablets and mobile used for closed loop marketing with or without customer relationship management platform.

In accordance with an embodiment of the present invention, the first set of user devices are computing devices with at least a processor, a memory and a display.

In accordance with an embodiment of the present invention, the first set of users is a sales representative, or any personnel involved in customer engagement activity through closed loop marketing.

According to a third aspect of the present invention, a system to author and access multimedia training content for closed loop marketing content is provided. The system comprises a first set of user devices operated by a first set of users, a second set of user devices operated by a second set of users, an authoring module, an information module, a closed loop marketing platform, a communication module and a communication network. Further, a communication module is configured to establish communication between first set of user devices, second set of user devices, an authoring module, an information module, a closed loop marketing platform through a communication network. Moreover, the second set of user devices operated by the second set of users are configured to author and create multimedia training content through authoring module for any particular closed loop marketing content of closed loop marketing platform and store as network-based resource in an information module. Additionally, the authoring module is configured to author and create the multimedia training content for any particular closed loop marketing content through synthesising or adding or recording video with audio or only audio narrating or describing associated closed loop marketing content, capture a second user interactions with closed loop marketing content in the background being navigated or changed or marked or opened and/or highlighted certain information in the closed loop marketing content as per video or audio narration timeline and get synchronized as interactivity data or media cue points, combine video with audio, audio, interactivity data and/or media cue points as multimedia training content associated to a closed loop marketing content and store the authored and created multimedia training content in the information module as network-based resource associates with the particular closed loop marketing content. To add to it, the information module is configured to store authored and created multimedia training content through an authoring module as network-based resource and provide access to multimedia training content to store or/and load, and render multimedia training content in the first set of user devices within closed loop marketing platform directly from information module through communication network or indirectly from device's local storage. Also, the first set of user devices operated by the first set of users are configured to open a closed loop marketing content within the closed loop marketing platform, access a user interface to load associated multimedia training content as a foreground overlay on top of the closed loop marketing content in the background, render and play the multimedia training content with the related video with audio or only audio narrating or describing associated closed loop marketing content in the background and simulate and animate the screen pointers, opening and/or highlighting the certain information in the associated closed loop marketing content in sync with video or audio narration timeline as per interactivity data or media cue points data. Furthermore, the closed loop marketing platform is configured to get accessed from the first set of user devices operated by the first set of users and enable further access to open any closed loop marketing content within the closed loop marketing platform along with a user interface to load, render and play associated multimedia training content directly from the information module through communication network or indirectly from device's local storage after downloading the multimedia training content from information module.

In accordance with an embodiment of the present invention, the closed loop marketing platform is further configured with in-built or external customer relationship management platform.

In accordance with an embodiment of the present invention, the closed loop marketing content is a multimedia digital content used for closed loop marketing by first set of users on first set of user devices.

In accordance with an embodiment of the present invention, the second set of user devices are computing devices with at least a processor, a memory and a display.

In accordance with an embodiment of the present invention, the second set of users are personnel involved in authoring the multimedia training content for any particular closed loop marketing content.

In accordance with an embodiment of the present invention, the closed loop marketing platform is one or multiple integrated computer software applications run on servers, tablets and mobile used for the closed loop marketing with or without customer relationship management platform.

In accordance with an embodiment of the present invention, the first set of user devices is a computing device with minimum a processor, a memory, a display.

In accordance with an embodiment of the present invention, the first set of users are sales representatives, or any personnel involved in customer engagement activity through closed loop marketing.

In accordance with an embodiment of the present invention, synthesising includes speech synthesis generating an audio from provided narration text data, also producing a video of an animated avatar with mouth and lip movements synchronized as per audio narration data.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1A illustrates a system to author and access multimedia training content for closed loop marketing content, in accordance with an embodiment of the present invention;

FIG. 1B illustrates a system to author and access multimedia training content for closed loop marketing content, in accordance with another embodiment of the present invention;

FIG. 1C illustrates a system to author and access multimedia training content for closed loop marketing content, in accordance with yet another embodiment of the present invention;

FIG. 2A illustrates a computer implemented method to author and access multimedia training content for closed loop marketing content, in accordance with an exemplary embodiment of the present invention;

FIG. 2B illustrates a computer implemented method for authoring multimedia training content, in accordance with an embodiment of the present invention;

FIG. 2C illustrates a computer implemented method for rendering and playing the multimedia training content, in accordance with an embodiment of the present invention;

FIG. 3A-3D illustrate an implementation of the system of the FIG. 1, in accordance with an exemplary embodiment of the present invention; and

FIG. 4 illustrates a computer implemented method to access multimedia training content for closed loop marketing content, in accordance with another exemplary embodiment of the present invention.

### DETAILED DESCRIPTION OF THE DRAWINGS

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” be used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

Further, the various embodiments described herein below include specific method steps in an exemplary order, but a wide variety of other such method steps could be implemented within the scope of the invention, including additional steps, omission of some steps, or performing the method in a different order.

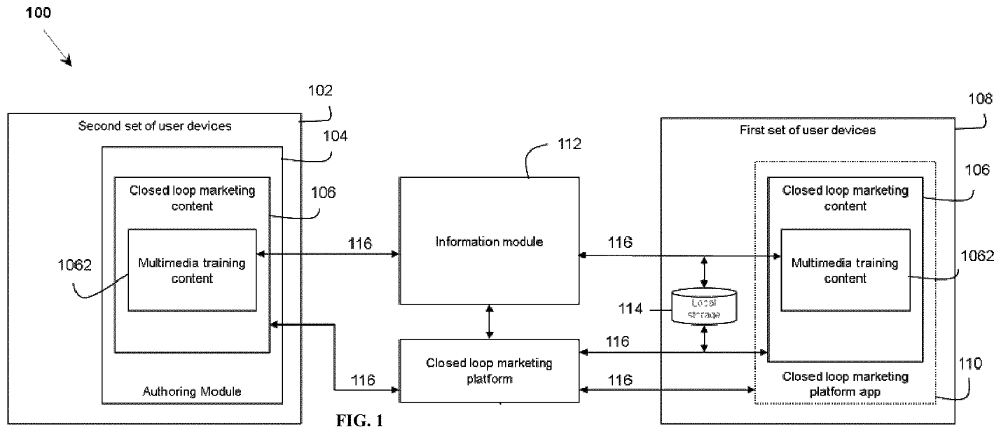

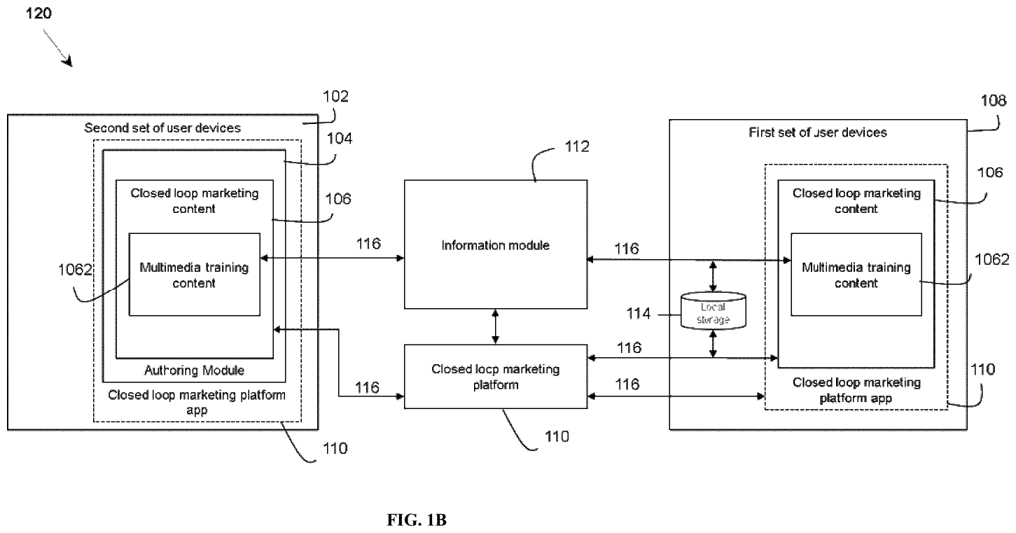

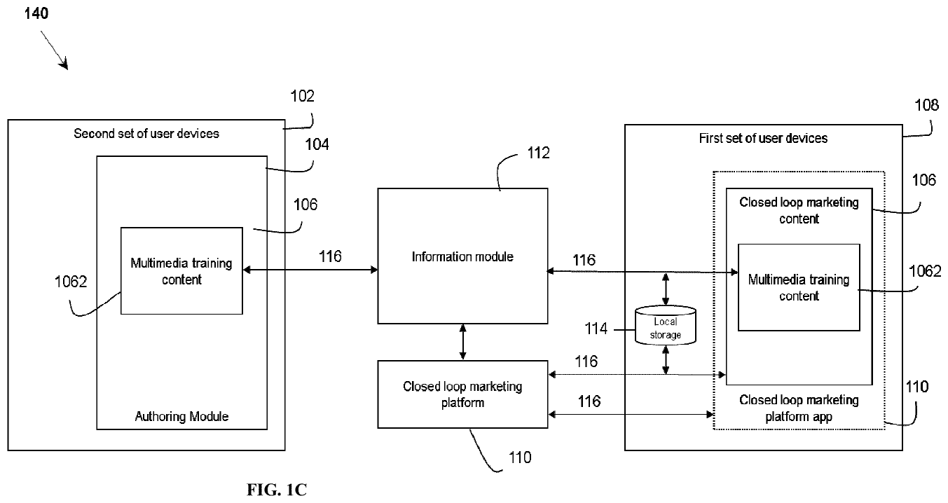

FIG. 1A illustrates a system (100) to author and access multimedia training content (1062) for closed loop marketing content (106), in accordance with an embodiment of the present invention. As shown in FIG. 1A, the system (100) comprises, but not limited to, a first set of user devices (108) operated by a first set of users, a second set of user devices (102) operated by a second set of users, a closed loop marketing platform (110), an information module (112), a authoring module (104), a communication module (not shown) and a communication network (116).

The closed loop marketing content is a multimedia training content (1062) used for closed loop marketing by first set of users on first set of user devices (108). In one embodiment, the closed loop marketing content contains certain anchor tags, IDs and script codes to enable multimedia training content (1062) to evoke certain functions or method or actions of closed loop marketing content (106). In another embodiment, the closed loop marketing content contains a script code to evoke and load a user interface (not shown in FIG. 1) to access the multimedia training content (1062) associated with the closed loop marketing content (106).

In accordance with an exemplary embodiment of the present invention, the first set of users devices and the second set of user devices (102) may be computing devices with at least a processor, a memory and a display such as, but not limited to, smartphone, a tablet, a desktop PC or laptop computing devices. The first set of users may be, but not limited to, sales representatives, or any personnel involved in customer engagement activity through closed loop marketing. The second set of users may be, but not limited to, personnel involved in authoring the multimedia training content (1062) of any particular closed loop marketing content (106).

These first set of user devices (108) and/or the second set of user devices (102) may comprise or may be externally connected to, but not limited to, a closed loop marketing platform (110). The closed loop marketing platform (110) is one or multiple integrated computer software applications run on servers, tablets and mobile used for closed loop marketing with or without Customer Relationship Management (CRM) platform. In one embodiment, the closed loop marketing platform (110) is configured to be operated by the first set of users through first set of user devices (108). The first set of users are enabled with access to open any closed loop marketing content along with the user interface to load, render and play associated multimedia training content (1062) within the closed loop marketing platform (110) directly from information module (112) through communication network (116) or indirectly from device's local storage (114) after downloading the multimedia training content (1062) from information module (112).

The authoring module (104) is envisaged to include computing capabilities such as a memory unit (not shown) configured to store machine readable instructions. The machine-readable instructions may be loaded into the memory unit from a non-transitory machine-readable medium such as, but not limited to, CD-ROMs, DVD-ROMs and Flash Drives. Alternately, the machine-readable instructions may be loaded in a form of a computer software program into the memory unit. The memory unit in that manner may be selected from a group comprising EPROM, EEPROM and Flash memory.

Further, the authoring module (104) includes a processor or plurality of high-speed computing processors with multiple cores (not shown) operably connected with the memory unit. In various embodiments, the processor is one of, but not limited to, a general-purpose processor, an application specific integrated circuit (ASIC) and a field-programmable gate array (FPGA).

Furthermore, the communication module (not shown) is configured to establish communication between first set of user devices (108), second set of user devices (102), an authoring module (104), an information module (112), a closed loop marketing platform (110) through a communication network (116). The communication network (116) may be one of, but not limited to, wired network or wireless network or a Local Area Network (LAN) or a Wide Area Network (WAN). The communication network (118) may be implemented using a number of protocols, such as but not limited to, TCP/IP, 3GPP, 3GPP2, LTE, IEEE 802.x, HTTP, HTTPS, UDP, RTMP etc. One would appreciate that the communication network (116) can be a short-range communication network and/or a long-range communication network, wired or wireless communication network. Preferably the communication network is internet.

Additionally, the information module (112) is also envisaged to include computing capabilities such as a memory unit (not shown) configured to store machine readable instructions. The machine-readable instructions may be loaded into the memory unit from a non-transitory machine-readable medium such as, but not limited to, CD-ROMs, DVD-ROMs and Flash Drives. Alternately, the machine-readable instructions may be loaded in a form of a computer software program into the memory unit. The memory unit in that manner may be selected from a group comprising EPROM, EEPROM and Flash memory.

Further, the information module (112) includes a processor or plurality of high-speed computing processors with multiple cores (not shown) operably connected with the memory unit and data storage unit. In various embodiments, the processor is one of, but not limited to, a general-purpose processor, an application specific integrated circuit (ASIC) and a field-programmable gate array (FPGA). The information module (112) is configured to store all the created the closed loop marketing content as a network-based resource.

In one embodiment, the authoring module (104) and the information module (112) may be a part of closed loop marketing platform (110) itself. Hence the second set of user devices operated by second set of users access the closed loop marketing platform then within authoring module to author multimedia training content for any particular closed loop marketing content. The same has been illustrated in FIG. 1B. In another embodiment, the information module (112) is a part of closed loop marketing platform (110) itself. The multimedia training content (1062) and associated closed loop marketing content reside together and are accessed and played together from a single data file package in first set of user devices (108).

In yet another embodiment illustrated in FIG. 1C, the authoring module (104) enables second set of user devices (102) operated by second set of users to author multimedia training content (1062) for any particular closed loop marketing content without loading them within authoring module (104). And they are referred and mapped by closed loop marketing content IDs and/or unique key message IDs.

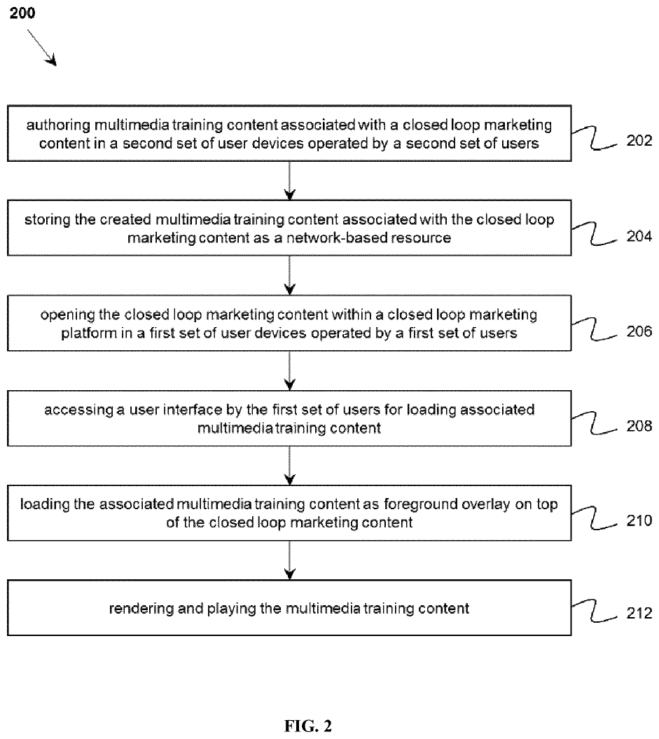

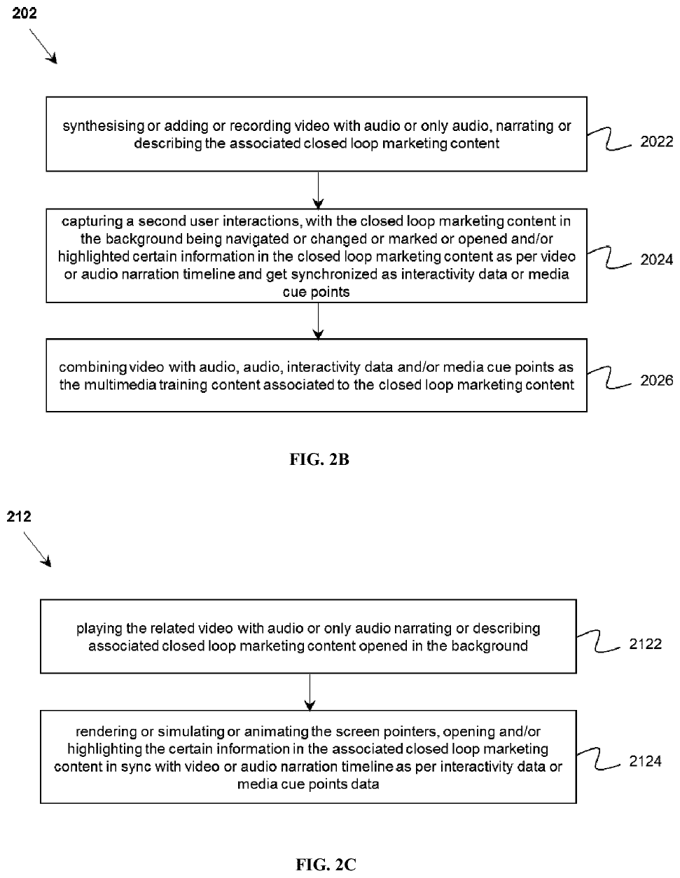

FIG. 2A illustrates a computer implemented method to author and access multimedia training content (1062) for closed loop marketing content (106), in accordance with an exemplary embodiment of the present invention. The method starts at step 202 by authoring the multimedia training content (1062) associated with the closed loop marketing content (106). The second set of user devices (102) operated by a second set of users, are configured to author and create multimedia training content (1062) through authoring module (104) for any particular closed loop marketing content available in closed loop marketing platform (110). In one embodiment, the closed loop marketing content is accessed/retrieved from the information module (112).

The authoring module (104) is configured to author and create the multimedia training content (1062) for the particular closed loop marketing content through synthesising or adding or recording video along with audio recording or only audio recording narrating or describing associated closed loop marketing content (106). The computer implemented method for the step of authoring has been illustrated in FIG. 2B. The authoring starts at step 2022, by synthesising or adding or recording video with audio or only audio, narrating or describing the associated closed loop marketing content (106). It may include speech synthesis, generating an audio from provided narration text data, also producing a video of an animated avatar with mouth and lip movements synchronized as per audio narration data. Then, at step 2024, the authoring module (104) captures interactions of a second user of the second set of users with the closed loop marketing content in the background being navigated or changes or marked or opened or highlighted certain information in the closed loop marketing content as per video or audio narration timeline and get synchronized as media cue points and/or interactivity data. Finally, at step 2026, the video with audio, audio, interactivity data and/or media cue points are combined as multimedia training content (1062) associated to the closed loop marketing content (106). In one embodiment of the present invention, the authoring module (104) authors the multimedia training content (1062) based on text data input embedded within the closed loop marketing content (106). This automates the audio narration and interactivity creation.

Returning to FIG. 2A, at step 204, the authored and created multimedia training content (1062) is stored in the information module (112) as network-based resource and is associated with a parclosede embodiment of the present invention, a copy of closed loop marketing content is placed within the information module (112) to load within the authoring module (104) while authoring the multimedia training content (1062).

After that, at step 206, the first set of user devices (108) operated by the first set of users are configured to open the closed loop marketing content within closed loop marketing platform (110). In another embodiment, the closed loop marketing content and relevant multimedia training content (1062) is downloaded and stored locally within the first set of user devices (108) through closed loop marketing platform (110), to avoid network dependency while playing the multimedia training content (1062).

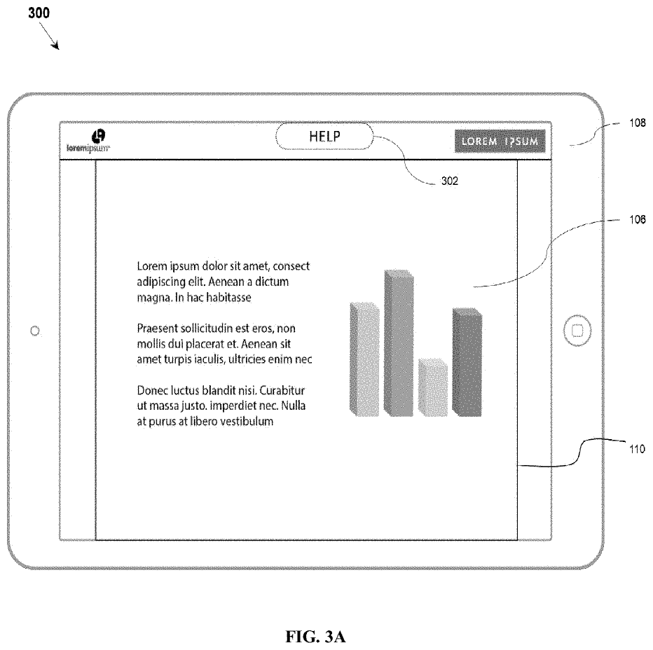

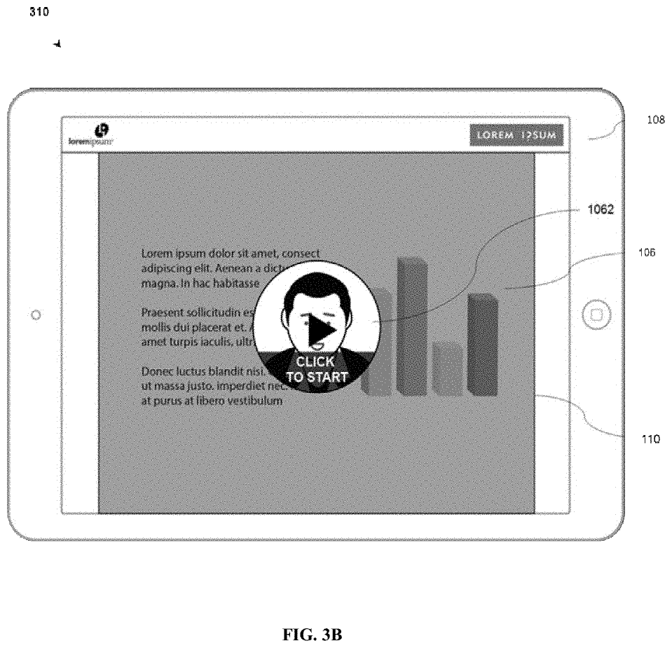

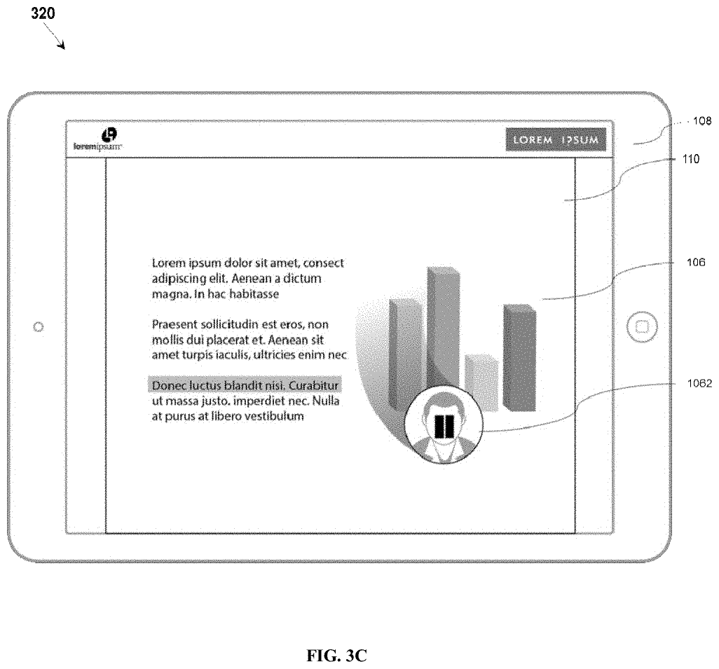

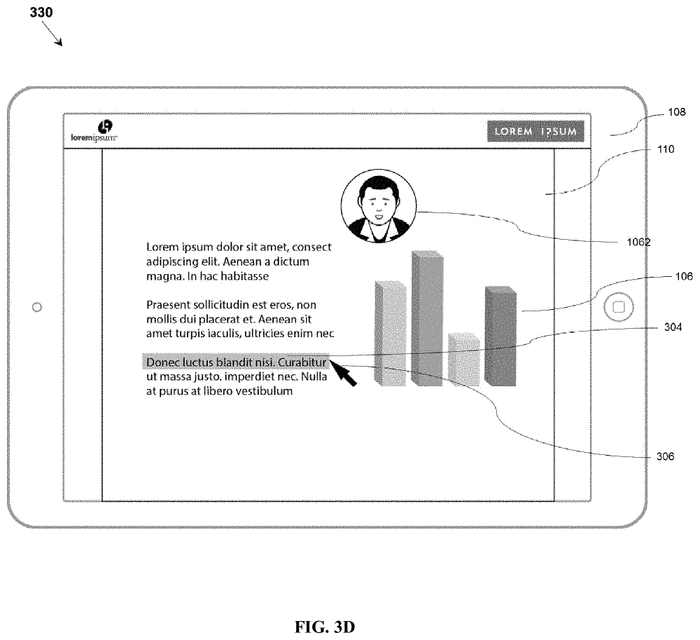

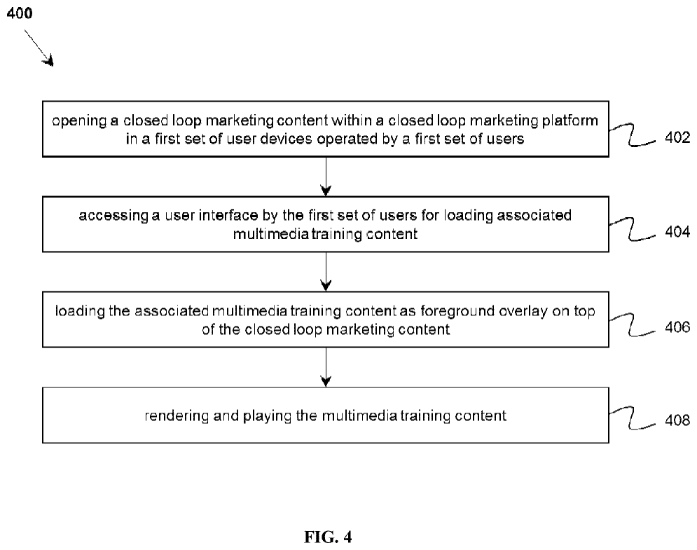

Then, at step 208, the first set of user devices (108) are configured to access a user interface (302) to load associated multimedia training content (1062). The same has been illustrated in FIG. 3A. Further, at step 210, the multimedia training content (1062) is loaded as foreground overlay on top of closed loop marketing content in the background, which has been illustrated in FIG. 3B. In one embodiment shown in FIG. 3C, the multimedia training content (1062) is draggable and movable as foreground overlay on top of closed loop marketing content (106). This enables the first user to easily refer the multimedia training content (1062) on the foreground and the information written on the background at the same time. In another embodiment, the closed loop marketing content and relevant multimedia training content (1062) is downloaded and stored locally within the first set of user's devices through closed loop marketing platform (110) to avoid network dependency while playing the multimedia training content (1062).

Additionally, at step 212, the first set of user devices (108) are configured to render and play the multimedia training content (1062). The computer implemented method for rendering and playing the multimedia training content (1062) has been illustrated in FIG. 2C. As shown in FIG. 2C, the method (212) starts at step 2122 by playing the related video with audio or only audio narrating or describing associated closed loop marketing content opened in the background. Then at step 2122, the method (212) includes simulating and animating the screen pointers (306), opening and/or highlighting (304) the certain information in the associated closed loop marketing content in sync with video or audio narration timeline as per interactivity data or media cue points data. The same has been illustrated in FIG. 3D. This helps to increase the interactivity of the multimedia training content (1062) as well as helps the first users to easily refer to the portions that are important and are being cited in the content.

To summarise, in the typical embodiment illustrated in FIG. 1A, the authoring module (104) enables second set of user devices (102) operated by second set of users to author multimedia training content (1062) for any particular closed loop marketing content (106). And they are referred and mapped by closed loop marketing content IDs and/or unique key message IDs and/or multimedia training content IDs. This enables first set of user devices (108) operated by first set of users within closed loop marketing platform (110) to open any available closed loop marketing content (106), then access a user interface (302) to load and play associated/referred/mapped multimedia training content (1062) on top of closed loop marketing content as foreground overlay.

In accordance with another embodiment of the present invention, the authoring module (104) may be configured to create the simulation based embedded multimedia training content (1062), in multiple languages, by using Artificial Intelligence based BOT avatar, machine voice as per provided narration script along with digital material slides being navigated or changes or marked or highlighted certain information in the slide as per BOT avatar video/audio/machine voice narration or description and get synchronized. The authoring module (104) may provide an interfaces to create simulation based embedded multimedia training content (1062) comprising a video of a BOT avatar with machine voice as per provided narration script or an audio & video of a second set of users recorded directly in authoring module (104) or uploaded existing media content to render/play as an overlay content on top of the digital material slides within the closed loop marketing platform (110).

In accordance with yet another embodiment, there is provided a computer implemented method (400) to access multimedia training content (1062) for a closed loop marketing content (106). The method (400) only focuses on enabling the first users operating the first set of user devices (108) to access/view the closed loop marketing content using the closed loop marketing platform (110). The method (400) starts at step 402 by opening the closed loop marketing content within a closed loop marketing platform (110) in a first set of user devices (108) operated by a first set of users. Then, at step 404, the user interface (302) may be accessed by the first set of users on the first set of user devices (108) for loading associated multimedia training content (1062). After that at step 406, the associated multimedia training content (1062) is loaded as a foreground overlay on top of the closed loop marketing content (106). Finally, at step 408, the multimedia training content (1062) is rendered and played at the first set of user devices.

Examples of the computing device may include, but are not limited to, a personal computer, a portable computing device, a tablet, a laptop, a mobile computer, a wearable computer, a communication device such as a smartphone, and a personal digital assistant, and the like. Moreover, the computing device includes a plurality of electronic components for example, such as a microprocessor, a graphics processor unit (GPU), a memory unit, a power source and a user interface. Exemplary user interface includes one or more buttons, a gesture interface, a knob, an audio interface, and a touch-based interface, and the like.

Further, one would appreciate that the communication network can be a short-range communication network and/or a long-range communication network, wire or wireless communication network. The communication interface includes, but not limited to, a serial communication interface, a parallel communication interface or a combination thereof.

Exemplary relevant content may include, but not limited to, audio, graphics, video, animation, interactivity, polls, surveys, URLs, embedded media players to render media content and combination thereof.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof.

Various modifications to these embodiments are apparent to those skilled in the art from the description. The principles associated with the various embodiments described herein may be applied to other embodiments. Therefore, the description is not intended to be limited to the embodiments but is to be providing broadest scope consistent with the principles and the novel and inventive features disclosed or suggested herein. Accordingly, the invention is anticipated to hold on to all other such alternatives, modifications, and variations that fall within the scope of the present invention and the appended claims.

1. A computer implemented method to author and access multimedia training content for closed loop marketing content, the method comprising the steps of:
authoring multimedia training content associated with a closed loop marketing content in a second set of user devices operated by a second set of users;
storing the created multimedia training content associated with the closed loop marketing content as a network-based resource;
opening the closed loop marketing content within a closed loop marketing platform in a first set of user devices operated by a first set of users;
accessing a user interface by the first set of users for loading associated multimedia training content;
loading associated multimedia training content as a foreground overlay on top of the closed loop marketing content; and
rendering and playing the multimedia training content.

2. The method as claimed in claim 1, wherein the step of authoring further comprises:
synthesising or adding or recording video with audio or only audio, narrating or describing the associated closed loop marketing content;
capturing a second user interactions, with the closed loop marketing content in the background being navigated or changed or marked or opened and/or highlighted certain information in the closed loop marketing content as per video or audio narration timeline and get synchronized as interactivity data or media cue points; and
combining video with audio, audio, interactivity data and/or media cue points as the multimedia training content associated to the closed loop marketing content.

3. The method as claimed in claim 1, wherein the step of rendering and playing further comprises:
playing the related video with audio or only audio narrating or describing associated closed loop marketing content opened in the background;
rendering or simulating or animating the screen pointers, opening and/or highlighting the certain information in the associated closed loop marketing content in sync with video or audio narration timeline as per interactivity data or media cue points data.

4. The method as claimed in claim 1, wherein the closed loop marketing content is a multimedia digital content used for closed loop marketing by first set of users on first set of user devices.

5. The method as claimed in claim 1, wherein the second set of user devices is a computing device with at least a processor, a memory and a display.

6. The method as claimed in claim 1, wherein the second set of users are personnel involved in authoring the multimedia training content for any particular closed loop marketing content.

7. The method as claimed in claim 1, wherein the closed loop marketing platform is one or multiple integrated computer software applications run on servers, tablets and mobile used for closed loop marketing with or without customer relationship management platform.

8. The method as claimed in claim 1, wherein the first set of user devices are computing devices with at least a processor, a memory and a display.

9. The method as claimed in claim 1, wherein the first set of users is a sales representative, or any personnel involved in customer engagement activity through closed loop marketing.

10. The method as claimed in claim 2, wherein the synthesising includes speech synthesis, generating an audio from provided narration text data, also producing a video of an animated avatar with mouth and lip movements synchronized as per audio narration data.

11. A computer implemented method to access multimedia training content for a closed loop marketing content, the method comprising the steps of:
opening the closed loop marketing content within a closed loop marketing platform in a first set of user devices operated by a first set of users;
accessing a user interface by the first set of users for loading associated multimedia training content;
loading associated multimedia training content as a foreground overlay on top of the closed loop marketing content; and
rendering and playing the multimedia training content.

12. The method as claimed in claim 11, wherein the step of rendering and playing further comprises:
playing the related video with audio or only audio narrating or describing associated closed loop marketing content opened in the background;
rendering or simulating or animating the screen pointers, opening and/or highlighting the certain information in the associated closed loop marketing content in sync with video or audio narration timeline as per interactivity data or media cue points data.

13. The method as claimed in claim 11, wherein the closed loop marketing content is a multimedia digital content used for closed loop marketing by first set of users on first set of user devices

14. The method as claimed in claim 11, wherein the closed loop marketing platform is one or multiple integrated computer software applications run on servers, tablets and mobile used for closed loop marketing with or without customer relationship management platform.

15. The method as claimed in claim 11, wherein the first set of user devices are computing devices with at least a processor, a memory and a display.

16. The method as claimed in claim 11, wherein the first set of users is a sales representative, or any personnel involved in customer engagement activity through closed loop marketing.

17. A system to author and access multimedia training content for closed loop marketing content, the system comprising:
a first set of user devices operated by a first set of users;
a second set of user devices operated by a second set of users;
an authoring module;
an information module;
a closed loop marketing platform;
a communication module; and
a communication network;
wherein the communication module is configured to establish communication between first set of user devices, second set of user devices, an authoring module, an information module, a closed loop marketing platform through the communication network;
wherein the second set of user devices operated by the second set of users are configured to author and create multimedia training content through authoring module for any particular closed loop marketing content of closed loop marketing platform and store as network-based resource in an information module;
wherein the authoring module is configured to:
author and create the multimedia training content for any particular closed loop marketing content through synthesising or adding or recording video with audio or only audio narrating or describing associated closed loop marketing content;
capture a second user interactions with closed loop marketing content in the background being navigated or changed or marked or opened and/or highlighted certain information in the closed loop marketing content as per video or audio narration timeline and get synchronized as interactivity data or media cue points;
combine video with audio, audio, interactivity data and/or media cue points as multimedia training content associated to a closed loop marketing content;
store the authored and created multimedia training content in the information module as network-based resource associates with the particular closed loop marketing content;
wherein the information module is configured to:
store authored and created multimedia training content through an authoring module as network-based resource;
provide access to multimedia training content to store in local storage or/and load, and render multimedia training content in the first set of user devices within closed loop marketing platform directly from information module through communication network or indirectly from device's local storage; wherein the first set of user devices operated by the first set of users are configured to:
open the closed loop marketing content within the closed loop marketing platform;
access a user interface to load associated multimedia training content as a foreground overlay on top of the closed loop marketing content in the background;
render and play the multimedia training content with the related video with audio or only audio narrating or describing associated closed loop marketing content in the background;
simulate and animate the screen pointers, opening and/or highlighting the certain information in the associated closed loop marketing content in sync with video or audio narration timeline as per interactivity data or media cue points data;
wherein the closed loop marketing platform is configured to:
get accessed from the first set of user devices operated by the first set of users;
enable further access to open any closed loop marketing content within the closed loop marketing platform along with a user interface to load, render and play associated multimedia training content directly from the information module through the communication network or indirectly from device's local storage after downloading the multimedia training content from information module.

18. The system as claimed in claim 17, wherein the closed loop marketing platform is further configured with in-built or external customer relationship management platform.

19. The system as claimed in claim 17, wherein the closed loop marketing content is a multimedia digital content used for closed loop marketing by first set of users on first set of user devices.

20. The system as claimed in claim 17, wherein the second set of user devices are computing devices with at least a processor, a memory and a display.

21. The system as claimed in claim 17, wherein the second set of users are personnel involved in authoring the multimedia training content for any particular closed loop marketing content.

22. The system as claimed in claim 17, wherein the closed loop marketing platform is one or multiple integrated computer software applications run on servers, tablets and mobile used for the closed loop marketing with or without customer relationship management platform.

23. The system as claimed in claim 17, wherein the first set of user devices is a computing device with minimum a processor, a memory, a display.

24. The system as claimed in claim 17, wherein the first set of users are sales representatives, or any personnel involved in customer engagement activity through closed loop marketing.

25. The system as claimed in claim 17, wherein synthesising includes speech synthesis, generating an audio from provided narration text data, also producing a video of an animated avatar with mouth and lip movements synchronized as per audio narration data.
